(19) United States
(12) Patent Application Publication
(10) Pub. No.: US 2014/0210220 A1
(43) Pub. Date: Jul. 31, 2014

(54) LATCH MECHANISM FOR A VEHICLE

(71) Applicant: STRATTEC Security Corporation, Milwaukee, WI (US)

(72) Inventors: Kurt Limberg, Milwaukee, WI (US); Michael Strole, Milwaukee, WI (US)

(73) Assignee: STRATTEC Security Corporation, Milwaukee, WI (US)

(21) Appl. No.: 14/167,278

(22) Filed: Jan. 29, 2014

Related U.S. Application Data
(60) Provisional application No. 61/759,068, filed on Jan. 31, 2013.

(51) Int. Cl. E05B 83/24

(52) U.S. Cl. CPC E05B 83/24
USPC 292/216

(57) ABSTRACT

A latch mechanism for a vehicle includes a mounting bracket defining a slot configured to receive a striker of the vehicle. The latch mechanism also includes a catch pivotally coupled to the mounting bracket. The catch is pivotable between a first position in which the catch allows removal of the striker from the slot, a second position in which the catch secures the striker within the slot, and a third position in which the catch pivots past the second position. The latch mechanism further includes a dampener element operable to slow movement of the catch as the catch pivots from the second position to the third position.

### CROSS-REFERENCE TO RELATED APPLICATIONS

This application claims priority to U.S. Provisional Patent Application Ser. No. 61/759,068, filed Jan. 31, 2013, the entire contents of which are incorporated by reference herein.

### FIELD OF THE INVENTION

The present application relates to latch mechanisms, such as hood latch mechanisms, for vehicles.

### SUMMARY

In some embodiments, the invention provides a latch mechanism for a vehicle. The latch mechanism includes a mounting bracket defining a slot configured to receive a striker of the vehicle. The latch mechanism also includes a catch pivotally coupled to the mounting bracket. The catch is pivotable between a first position in which the catch allows removal of the striker from the slot, a second position in which the catch secures the striker within the slot, and a third position in which the catch pivots past the second position. The latch mechanism further includes a dampener element operable to slow movement of the catch as the catch pivots from the second position to the third position.

In other embodiments, the invention provides a latch mechanism for a vehicle. The vehicle includes a frame and a hood pivotally coupled the frame. The latch mechanism includes a mounting bracket configured to mount to one of the frame and the hood. The mounting bracket defines a slot configured to receive a striker on the other of the frame and the hood. The latch mechanism also includes a catch pivotally coupled to the mounting bracket. The catch is pivotable between a first position in which the catch allows removal of the striker from the slot, a second position in which the catch secures the striker within the slot, and a third position in which the catch pivots past the second position. The latch mechanism further includes a dampener element mounted on the mounting bracket. The dampener element is configured to engage at least one of the striker and the catch as the catch pivots from the second position to the third position.

In further embodiments, the invention provides a vehicle including a frame, a hood pivotally coupled to the frame and having a striker, and a latch mechanism. The latch mechanism includes a mounting bracket mounted to the frame. The mounting bracket defines a slot that receives the striker of the vehicle. The latch mechanism also includes a catch pivotally coupled to the mounting bracket. The catch is pivotable between a first position in which the catch allows removal of the striker from the slot, a second position in which the catch secures the striker within the slot, and a third position in which the catch pivots past the second position. The latch mechanism further includes a biasing member coupled to the catch and the bracket to bias the catch toward the first position, and a dampener element operable to dampen movement of the striker and the catch as the catch pivots from the second position to the third position.

Other aspects of the invention will become apparent by consideration of the detailed description and accompanying drawings.

### BRIEF DESCRIPTION OF THE DRAWINGS

FIG. 1 is a front perspective view of a latch mechanism including a dampener element, the latch mechanism being mounted to a frame of a vehicle.

FIG. 2 is a rear perspective view of the latch mechanism including the dampener element.

FIG. 3 is a rear plan view of the latch mechanism with a catch pivoted to a first position and a striker in an unlocked position.

FIG. 4 is the rear plan view of the latch mechanism with the catch pivoted to a second position and the striker in the locked position.

FIG. 5 is the rear plan view of the latch mechanism with the catch pivoted to a third position and the striker in an over-travel position.

FIG. 6 illustrates the striker in the unlocked, locked, and over-travel positions relative to the dampener element.

FIG. 7 is an enlarged rear view of the dampener element coupled to the latch mechanism.

FIG. 8 is an enlarged top view of the dampener element coupled to the latch mechanism.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

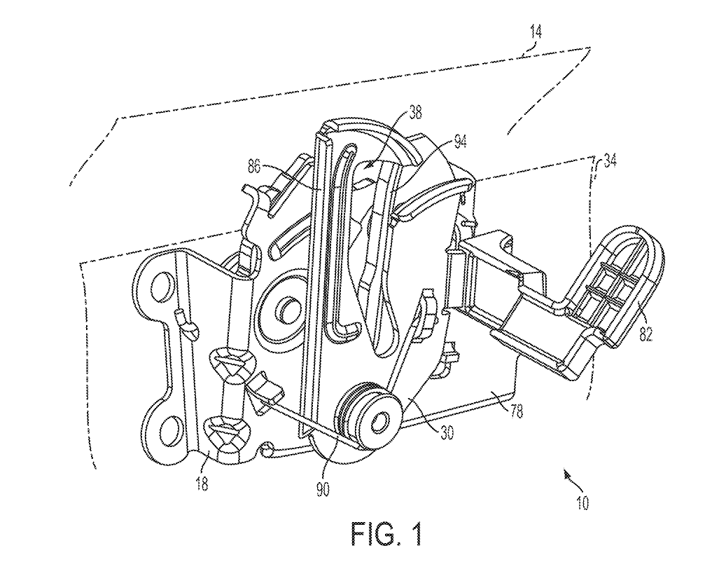

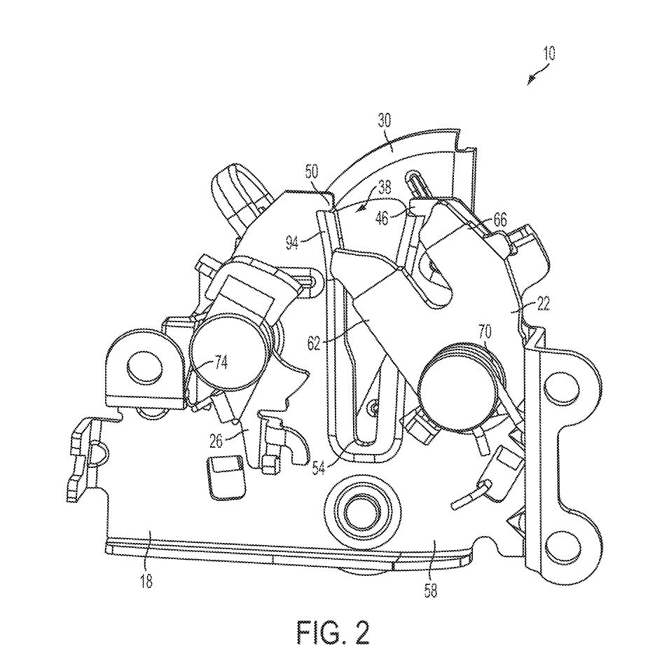

FIGS. 1 and 2 illustrate a latch mechanism 10 for use with a vehicle. In the illustrated embodiment, the latch mechanism 10 is configured to secure and selectively release a hood 14 of the vehicle. In other embodiments, the latch mechanism 10 may be used to secure and selectively release other elements of the vehicle, such as a trunk or a glove compartment.

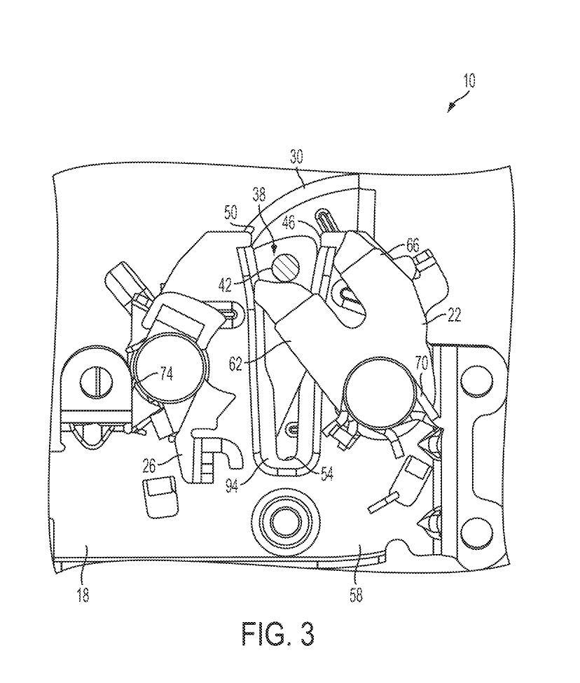

The illustrated latch mechanism 10 includes a mounting bracket 18, a catch 22, a pawl 26, and a release lever 30. The mounting bracket 18 mounts to a frame 34 of the vehicle and defines a slot 38 that receives a striker 42 (FIGS. 3-6) on the hood 14. In other embodiments, the striker 42 may be mounted to the frame 34, and the mounting bracket 18 may be mounted to the hood 14. The slot 38 is defined by an inner edge 46 of the bracket 18 and includes an open upper end 50 and a closed lower end 54. The striker 42 enters the slot 38 at the open end 50 and travels to a location generally halfway between the open and closed ends 50, 54 of the slot 38 when the hood 14 is closed.

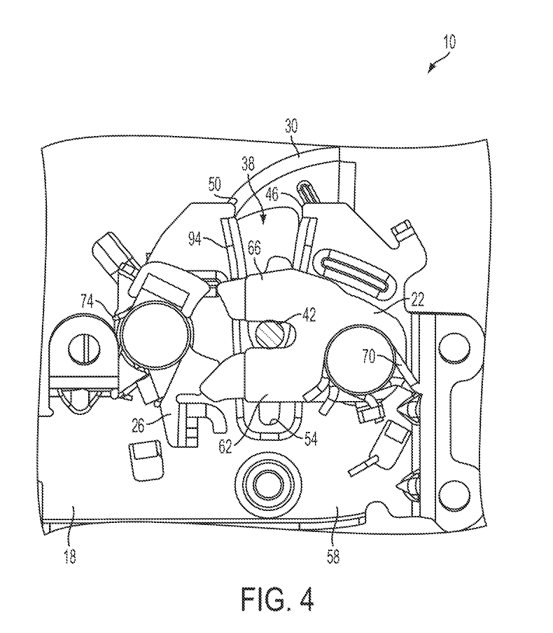

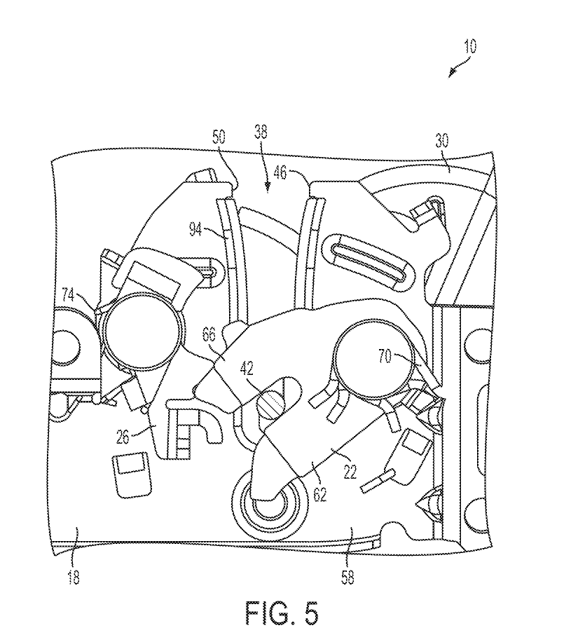

As shown in FIG. 2, the catch 22 is pivotally coupled to a rear side 58 of the bracket 18 adjacent the slot 38. A portion of the catch 22 extends over the slot 38 to guide and hold the striker 42 in the slot 38. In the illustrated embodiment, the catch 22 is generally C-shaped and includes a first jaw 62 and a second jaw 66. In other embodiments, other suitable catches may alternatively be employed. The catch 22 is pivotable relative to the bracket 18 between a first position (FIG. 3), a second position (FIG. 4), and a third position (FIG. 5) corresponding to three positions of the striker 42. In the first position, the catch 22 is pivoted to allow removal of the striker 42 from the slot 38. In the second position, the catch 22 receives the striker 42 between the jaws 62, 66 and is pivoted to lock the striker 42 in the slot 38. In the third position, the striker 42 is still received between the jaws 62, 66 of the catch 22, but the catch 22 is pivoted beyond the second position such that the striker 42 is located at the closed end 54 of the slot 38. Such a position may occur during, for example, a front-end collision of the vehicle that pushes the hood 14 into the frame 34. A biasing member 70 (e.g., a torsion spring) is coupled to the catch 22 and the bracket 18 to bias the catch 22 toward the first position.

The pawl 26 is pivotally coupled to the rear side 58 of the bracket 18 on an opposite side of the slot 38 from the catch 22. The pawl 26 engages the catch 22 when the catch 22 is in the second and third positions (FIGS. 4-5) to selectively hold the catch 22 in these positions. When the catch 22 is in the second position, the pawl 26 engages the first jaw 62 of the catch 22. When the catch 22 is in the third position, the pawl 26 engages the second jaw 66 of the catch 22. An actuator (not shown), such as a cable connected to a handle inside the vehicle, is coupled to the pawl 26 to selectively pivot the pawl 26 out of engagement with the catch 22, allowing the catch 22 to return to the first position (FIG. 3). A biasing member 74 (e.g., a torsion spring) is coupled to the pawl 26 and the bracket 18 to bias the pawl 26 toward the position shown in FIGS. 3-5 when the actuator is not actuated.

As shown in FIG. 1, the release lever 30 is pivotally coupled to a front side 78 of the bracket 18 opposite from the catch 22 and the pawl 26. The release lever 30 includes an actuator 82 and an arm 86. A portion of the arm 86 extends over the slot 38 to engage the striker 42 as the striker 42 exits the slot 38. The arm 86 thereby inhibits the hood 14 from flipping open (i.e., up) until a user manually actuates the actuator 82. Actuating the actuator 82 pivots the arm 86 away from the slot 38, allowing the striker 42 to completely disengage the latch mechanism 10 to open the hood 14. A biasing member 90 (e.g., a torsion spring) is coupled to the release lever 30 and the bracket 18 to bias the lever 30 toward the closed position shown in FIGS. 1-4.

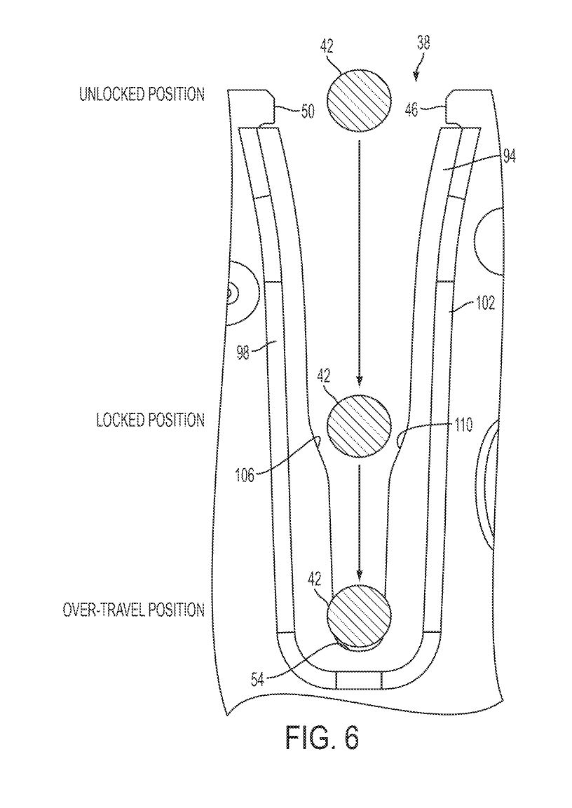

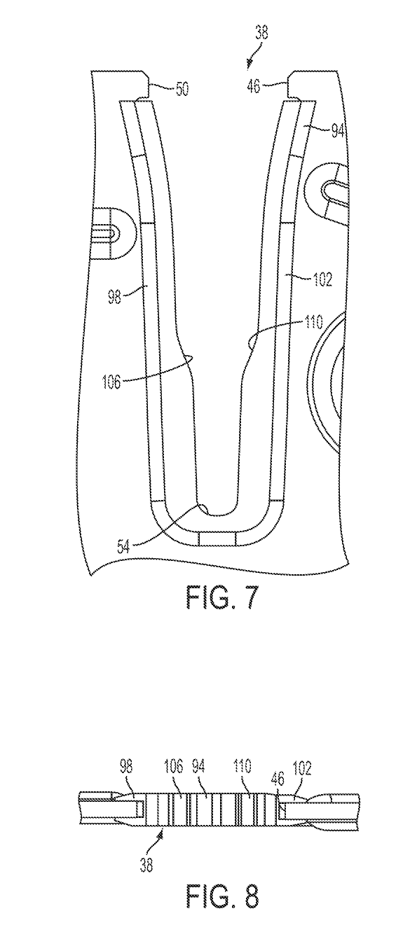

As shown in FIGS. 6-8, the latch mechanism 10 also includes a dampener element 94. In the illustrated embodiment, the dampener element 94 engages the striker 42 as the striker 42 moves from a locked position (FIG. 4, corresponding to the second position of the catch 22) to an over-travel position (FIG. 5, corresponding to the third position of the catch 22). The dampener element 94 thereby absorbs energy when the striker 42 and the catch 22 move past the second/locked position (e.g., during a front-end collision) to dampen movement of the striker 42. By dampening movement of the striker 42, the dampener element 94 also dampens movement of the catch 22. That is, the dampener element 94 slows the movement, or velocity, of both the striker 42 and the catch 22 as the catch 22 pivots from the second position to the third position. In some embodiments, such as the illustrated embodiment, the dampener element 94 directly engages the striker 42 to slow movement of the striker 42 and the catch 22. In other embodiments, the dampener element 94 may directly engage the catch 22, or may directly engage both the catch 22 and the striker 42, to slow movement of the striker 42 and the catch 22.

In the illustrated embodiment, the dampener element 94 is coupled to and extends along the inner edge 46 of the mounting bracket 18 that defines the slot 38. The dampener element 94 may be glued, molded, press-fit, laser welded, or otherwise secured on the inner edge 46. The illustrated dampener element 94 is composed of a plastic material, such as polyacetal (POM-C). In other embodiments, the dampener element 94 may be composed of other plastic or elastomeric materials or a combination of materials. Furthermore, the illustrated dampener element 94 extends along and covers the entire inner edge 46 of the mounting bracket 18. In other embodiments, the dampener element 94 may only extend along and cover a portion of the inner edge 46 (e.g., the portion of the inner edge 46 that defines the closed end 54 of the slot 38).

The illustrated dampener element 94 is generally U-shaped and includes two opposing legs 98, 102. The dampener element 94 also includes a wedge surface 106, 110 generally at a mid-portion along the length of each leg 98, 102. The wedge surfaces 106, 110 taper the dampener element 94 inwardly relative to the slot 38 such that the element 94 is thicker near the closed end 54 of the slot 38 than near the open end 50 of the slot 38. Due to the taper, a distance between the legs 98, 102 is greater than a diameter of the striker 42 near the open end 50 of the slot 38 (e.g., above the wedge surfaces 106, 110), but is smaller than the diameter of the striker 42 near the closed end 54 of the slot 38 (e.g., below the wedge surfaces 106, 110).

As shown in FIG. 6, the striker 42 is spaced apart from the dampener element 94 when the striker 42 is in an unlocked position (corresponding to the first position of the catch 22) and in the locked position. In these positions, the dampener element 94 does not engage, and thereby restrict or inhibit movement, of the striker 42. In the illustrated embodiment, the striker 42 is spaced about 4 millimeters vertically above the wedge surfaces 106, 110 when in the locked position. Such an arrangement helps to ensure the hood 14 is flush with the rest of the vehicle when closed. In other embodiments, the striker 42 may be spaced closer to or further from the wedge surfaces 106, 110 when the hood 14 is closed. In still other embodiments, the striker 42 may rest on the wedge surfaces 106, 110 when the hood 14 is closed.

The striker 42 engages the dampener element 94 when the striker 42 moves to the over-travel position. For example, sufficient downward pressure on the hood 14 can force the striker 42 to move past the locked position toward the closed end 54 of the slot 38. In some embodiments, such as the illustrated embodiment, the striker 42 moves about 16 millimeters through the slot 38 from the locked position to the over-travel position. As the striker 42 moves to the over-travel position, the striker 42 pushes against the first leg 62 of the catch 22, pivoting the catch 22 toward the third position. During this movement, the striker 42 also engages the wedge surfaces 106, 110 of the dampener element 94. Engagement between the striker 42 and the dampener element 94 deforms the dampener element 94, thereby dampening and slowing movement of the striker 42 to absorb force. The force absorption profile of the dampener element 94 as the striker 42 moves from the locked position to the over-travel position may be either linear or non-linear.

In some embodiments, the dampener element 94 may be removably coupled to the mounting bracket 18. In such embodiments, different dampener elements may be interchangeably coupled to the bracket 18 to “tune” the latch mechanism 10 for different force requirements. For example, dampener elements composed of different materials or having different shapes and/or sizes may alternatively be coupled to the bracket 18 to increase or decrease the amount of force that can be absorbed. Referring to FIG. 6, a distance between the unlocked and locked positions of the striker 42, a distance between the locked and over-travel positions of the striker 42, and/or an angle of the wedge surfaces 106, 110 may be adjusted to tune the illustrated dampener element 94.

Additionally or alternatively, the dampener element 94 may be positioned elsewhere on the latch mechanism 10 and may engage elements other than the striker 42, such as the catch 22, the pawl 26, or the mounting bracket 18. For example, in some embodiments, a dampener element, such as a bumper, may extend outwardly from the rear side 58 of the mounting bracket 18 adjacent the catch 22. In such embodiments, the dampener element 94 may engage the first jaw 62 of the catch 22 as the catch 22 pivots from the second position to the third position. In other embodiments, a dampener element, such as a coil spring, may extend axially from the closed end 54 of the slot 38, rather than along the inner edge 46 of the bracket 18. In such embodiments, the spring may compress as the striker 42 moves toward the closed end 54 of the slot 38. In still other embodiments, a dampener element, such as a bumper, may extend from the pawl 26 and the dampener may be configured to engage the second jaw 66 of the catch 22.

In further embodiments, the latch mechanism 10 may include multiple dampener elements to absorb forces as the striker 42 travels from the locked position to the over-travel position. In some such embodiments, one dampener element can be provided on the catch 22 (e.g., as an elastic coating over a rigid catch body) and a different dampener (with similar or different elasticity) can be provided on either the striker 42 or the bracket 18. For example, the latch mechanism 10 may include a first dampener element having wedge surfaces to provide a first damper zone and a second dampener element having a bumper to provide a second damper zone. The force absorption of the dampener elements may be tuned to meet the force requirements of a specific vehicle.

In some embodiments, a dampener element may be integrally formed with the bracket 18. For example, the dampener element may include a flared lip and/or narrow slots that are formed or stamped into the bracket 18 adjacent the inner edge 46. As the striker 42 moves from the locked position to the over-travel position, the striker 42 could directly engage the inner edge 46 via an interference fit. The flared lip and/or narrow slots in the bracket 18 could provide a dampening function to absorb forces during movement of the striker 42. In such embodiments, the dampener element may be formed of the same material as the bracket 18, or may be formed of an elastomeric material that is molded to the bracket 18.

Various features and advantages of the invention are set forth in the following claims.

What is claimed is:

1. A latch mechanism for a vehicle, the latch mechanism comprising:
a mounting bracket defining a slot configured to receive a striker of the vehicle;
a catch pivotally coupled to the mounting bracket, the catch pivotable between a first position in which the catch allows removal of the striker from the slot, a second position in which the catch secures the striker within the slot, and a third position in which the catch pivots past the second position; and
a dampener element operable to slow movement of the catch as the catch pivots from the second position to the third position.

2. The latch mechanism of claim 1, wherein the dampener element is mounted on the mounting bracket.

3. The latch mechanism of claim 2, wherein the mounting bracket includes an inner edge that defines the slot, and wherein the dampener element extends along at least a portion of the inner edge of the mounting bracket.

4. The latch mechanism of claim 3, wherein the dampener element is generally U-shaped.

5. The latch mechanism of claim 1, wherein the dampener element is deformed as the catch moves from the second position to the third position.

6. The latch mechanism of claim 1, wherein the dampener element includes a wedge surface, and wherein the wedge surface is configured to engage the striker as the catch pivots from the second position to the third position.

7. The latch mechanism of claim 1, wherein the dampener element is configured to be spaced apart from the striker when the catch is in the first and second positions.

8. The latch mechanism of claim 1, wherein the dampener element is composed of a plastic material.

9. The latch mechanism of claim 1, further comprising a pawl pivotally coupled to the mounting bracket, wherein the pawl engages the catch to releasably secure the catch in the second and third positions.

10. The latch mechanism of claim 1, further comprising a biasing member coupled to the catch and the mounting bracket, wherein the biasing member biases the catch toward the first position.

11. A latch mechanism for a vehicle, the vehicle including a frame and a hood pivotally coupled to the frame, the latch mechanism comprising:
a mounting bracket configured to mount to one of the frame and the hood, the mounting bracket defining a slot configured to receive a striker on the other of the frame and the hood;
a catch pivotally coupled to the mounting bracket, the catch pivotable between a first position in which the catch allows removal of the striker from the slot, a second position in which the catch secures the striker within the slot, and a third position in which the catch pivots past the second position; and
a dampener element mounted on the mounting bracket, the dampener element configured to engage at least one of the striker and the catch as the catch pivots from the second position to the third position.

12. The latch mechanism of claim 11, wherein the mounting bracket includes an inner edge that defines the slot, and wherein the dampener element extends along at least a portion of the inner edge of the mounting bracket

13. The latch mechanism of claim 12, wherein the dampener element is generally U-shaped.

14. The latch mechanism of claim 11, wherein the dampener element is deformed as the catch moves from the second position to the third position.

15. The latch mechanism of claim 11, wherein the dampener element includes a wedge surface, and wherein the wedge surface is configured to engage the striker as the catch pivots from the second position to the third position.

16. The latch mechanism of claim 11, wherein the dampener element is configured to be spaced apart from the striker when the catch is in the first and second positions.

17. The latch mechanism of claim 11, wherein the dampener element is composed of a plastic material.

18. The latch mechanism of claim 11, further comprising a pawl pivotally coupled to the mounting bracket, wherein the pawl engages the catch to releasably secure the catch in the second and third positions.

19. The latch mechanism of claim 11, further comprising a biasing member coupled to the catch and the mounting bracket, wherein the biasing member biases the catch toward the first position.

20. A vehicle comprising:
a frame;
a hood pivotally coupled to the frame and including a striker; and
a latch mechanism including
a mounting bracket mounted to the frame, the mounting bracket defining a slot that receives the striker,
a catch pivotally coupled to the mounting bracket, the catch pivotable between a first position in which the catch allows removal of the striker from the slot, a second position in which the catch secures the striker within the slot, and a third position in which the catch pivots past the second position,
a biasing member coupled to the catch and the mounting bracket to bias the catch toward the first position, and
a dampener element operable to dampen movement of the striker and the catch as the catch pivots from the second position to the third position.
